(19) United States
(12) Patent Application Publication
(10) Pub. No.: US 2026/0228026 A1
(43) Pub. Date: Aug. 6, 2026

(54) SYSTEM, SERVER DEVICE, INFORMATION PROCESSING DEVICE, AND VEHICLE

(71) Applicant: TOYOTA JIDOSHA KABUSHIKI KAISHA, Toyota-shi (JP)

(72) Inventor: Ayako TAKIZAKI, Okazaki-shi (JP)

(73) Assignee: TOYOTA JIDOSHA KABUSHIKI KAISHA, Toyota-shi (JP)

(21) Appl. No.: 19/451,876

(22) Filed: Jan. 16, 2026

(30) Foreign Application Priority Data
Feb. 6, 2025 (JP) 2025-018752

(51) Int. Cl. G06F 9/451

(52) U.S. Cl. CPC G06F 9/454

(57) ABSTRACT

A system includes a server device and an information processing device installed in a vehicle. The server device is configured to select a first terms-of-service text corresponding to a region associated with the vehicle from among a plurality of terms-of-service texts, and preferentially select a terms-of-service text corresponding to a language for text display set in the information processing device as the first terms-of-service text. The terms-of-service texts each correspond to a different combination of a region and a language and include terms of use for the corresponding region written in the corresponding language. The server device is configured to transmit the selected first terms-of-service text to the information processing device via a network.

### CROSS-REFERENCE TO RELATED APPLICATION

This application claims priority to Japanese Patent Application No. 2025-018752 filed on February 6, 2025. The disclosure of the above-identified application, including the specification, drawings, and claims, is incorporated by reference herein in its entirety.

### BACKGROUND

### Technical Field

The present disclosure relates to a system, a server device, an information processing device, and a vehicle.

### Description of Related Art

Japanese Unexamined Patent Application Publication No. 2020-135813 (JP 2020-135813 A) discloses a device that displays a screen that allows a user riding in a vehicle to select whether to agree to the provision of information and transmits the information to the outside of the vehicle when the user agrees. This device displays the terms and conditions regarding the provision of personal information on the screen.

### SUMMARY

In some regions, regulations require that the full text of the terms of use of a connected service be displayed on the screen of an in-vehicle device. In such regions, it is conceivable that the in-vehicle device connects to a terms-of-service display website using a web browser function and displays a terms-of-service text on the website.

However, a terms-of-service text suitable for the user may be different, depending on the combination of country, brand, and language to be supported. While it is conceivable to allow the user to manually select a combination of country, brand, and language on the website, this may be troublesome for the user. Although this still may satisfy the regulations, it is not necessarily desirable that it take time to display an appropriate terms-of-service text, that the user be confused about how to select a terms-of-service text, or that the terms-of-service text be displayed in a display language that is not suitable for the user.

The present disclosure provides a technique that enables automatically displaying a terms-of-service text suitable for a user.

An aspect of the present disclosure provides a server device including: a communication unit that is configured to communicate with an information processing device installed in a vehicle; and a processor configured to select a first terms-of-service text corresponding to a region associated with the vehicle from among a plurality of terms-of-service texts, and transmit the selected first terms-of-service text to the information processing device via the communication unit. The terms-of-service texts each correspond to a different combination of a region and a language and include terms of use for the corresponding region written in the corresponding language. The processor is configured to preferentially select a terms-of-service text corresponding to a language for text display set in the information processing device as the first terms-of-service text.

An aspect of the present disclosure provides an information processing device installed in a vehicle, including: a communication unit that is configured to communicate with a server device; and a processor configured to when a first terms-of-service text corresponding to a region associated with the vehicle and selected from among a plurality of terms-of-service texts is received from the server device, display the received terms-of-service text on a display mounted on the vehicle, and when a user input indicating that a user agrees to terms of use included in a displayed terms-of-service text is received via an input device mounted on the vehicle, transmit information collected in the vehicle to the server device via the communication unit. A terms-of-service text corresponding to a language for text display set in the information processing device is preferentially selected as the first terms-of-service text. The terms-of-service texts each correspond to a different combination of a region and a language, and include terms of use for the corresponding region written in the corresponding language.

According to the present disclosure, a terms-of-service text suitable for a user can be automatically displayed.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating the configuration of a system according to an embodiment of the present disclosure;

FIG. 2 illustrates an example of a vehicle including an information processing device according to the embodiment of the present disclosure;

FIG. 3 is a block diagram illustrating the connection between the information processing device and in-vehicle devices according to the embodiment of the present disclosure;

FIG. 4 is a sequence diagram illustrating an example of the procedure for communication between the information processing device and a server device according to the embodiment of the present disclosure;

FIG. 5 is a flowchart illustrating the operation of the server device according to the embodiment of the present disclosure;

FIG. 6 is a flowchart illustrating the operation of the information processing device according to the embodiment of the present disclosure; and

FIG. 7 is a flowchart illustrating a modification of the operation of the server device according to the embodiment of the present disclosure.

### DETAILED DESCRIPTION OF EMBODIMENTS

An embodiment of the present disclosure will be described below with reference to the drawings.

In each drawing, the same or corresponding portions are denoted by the same reference signs. In the description of the present embodiment, description of the same or corresponding portions will be omitted or simplified as appropriate.

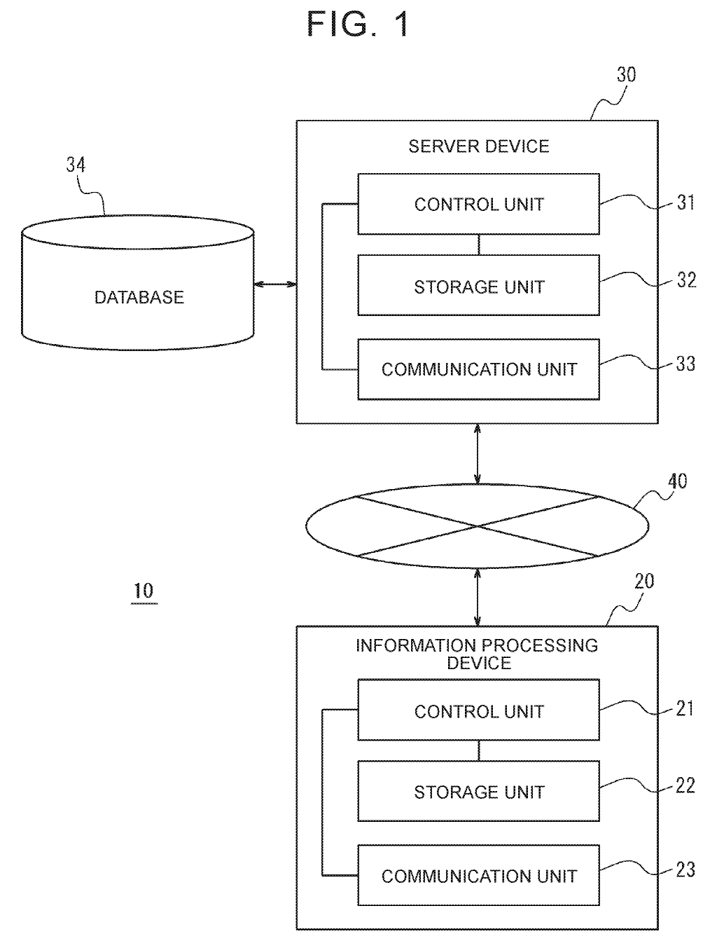

The configuration of a system 10 according to the present embodiment will be described with reference to FIG. 1.

The system 10 according to the present embodiment includes an information processing device 20 and a server device 30. The information processing device 20 is capable of communicating with the server device 30 via a network 40.

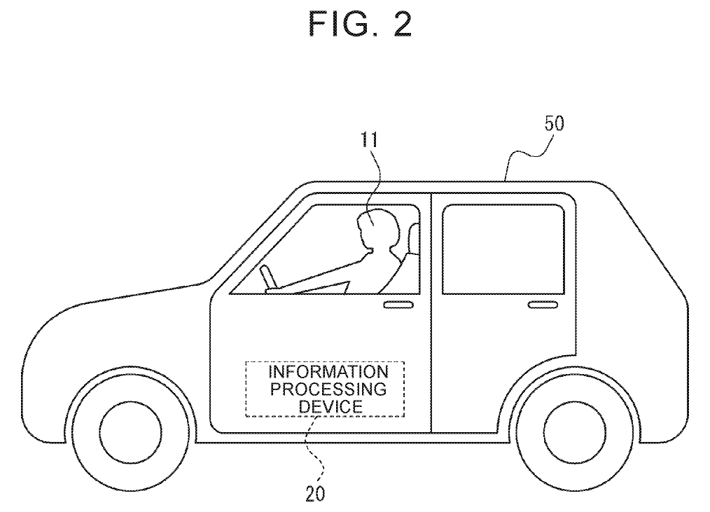

The information processing device 20 is a computer such as a microcomputer or an ECU, or is a device obtained by combining such a computer with a different device such as a communication device. The term "ECU" is an abbreviation for "electronic control unit". As illustrated in FIG. 2, the information processing device 20 is installed in a vehicle 50.

The vehicle 50 is an automobile of any type, such as a gasoline vehicle, a diesel vehicle, a hydrogen vehicle, an HEV, a PHEV, a BEV, or an FCEV. The term "HEV" is an abbreviation for "hybrid electric vehicle". The term "PHEV" is an abbreviation for "plug-in hybrid electric vehicle". The term "BEV" is an abbreviation for "battery electric vehicle". The term "FCEV" is an abbreviation for "fuel cell electric vehicle". In the present embodiment, the vehicle 50 is driven by a user 11. However, the driving may be automated at any level. The level of autonomous driving is one of Levels 1 to 5 defined by the SAE, for example. The term "SAE" is an abbreviation for "Society of Automotive Engineers". The vehicle 50 may be a MaaS dedicated vehicle. The term "MaaS" is an abbreviation for "Mobility as a Service".

The server device 30 is a server computer such as a cloud server. The server device 30 is installed in a facility such as a data center. The server device 30 is connected to a database 34 either directly through a wired or wireless connection or via the network 40. As a modification, the server device 30 may include the database 34 itself.

The network 40 includes the Internet, at least one WAN, at least one MAN, or any combination of these. The term "WAN" is an abbreviation for "wide area network". The term "MAN" is an abbreviation for "metropolitan area network". The network 40 may include at least one wireless network, at least one optical network, or any combination of these. The wireless network is, for example, an ad hoc network, a cellular network, a wireless LAN, a satellite communication network, or a terrestrial microwave network. The term "LAN" is an abbreviation for "local area network".

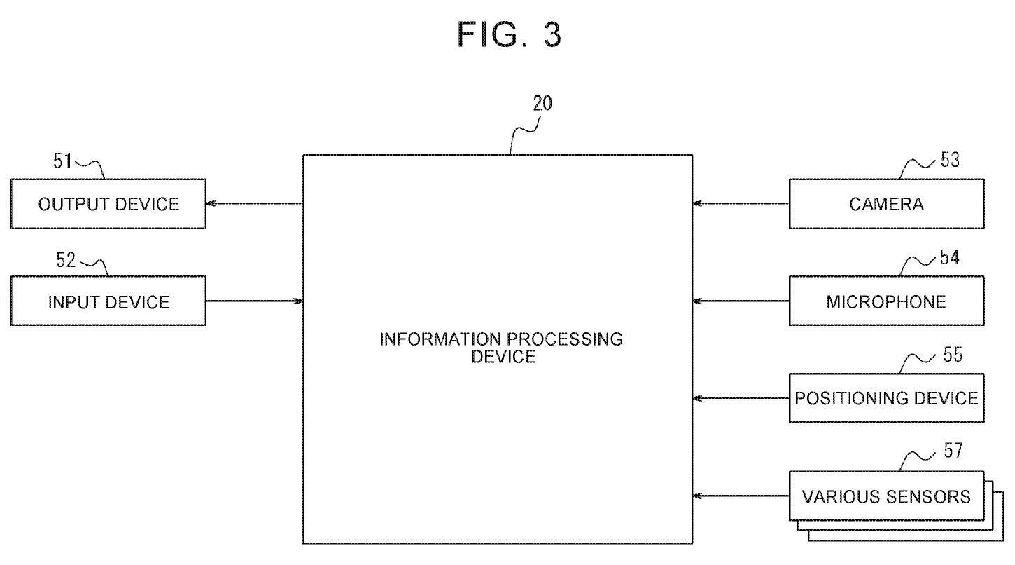

As illustrated in FIG. 3, in the present embodiment, the information processing device 20 is connected to various devices mounted on the vehicle 50, such as an output device 51, an input device 52, a camera 53, a microphone 54, a positioning device 55, and various sensors 57. As an interface for connection with the various devices, an interface conforming to a standard such as USB, HDMI (registered trademark), or Bluetooth (registered trademark) can be used. The term "USB" is an abbreviation for "Universal Serial Bus". The term "HDMI (registered trademark)" is an abbreviation for "High-Definition Multimedia Interface". The information processing device 20 may be connected to the various devices via an in-vehicle network such as a CAN. The term "CAN" is an abbreviation for "Controller Area Network". As a modification, the information processing device 20 may itself include one or more devices, among the various devices mounted on the vehicle 50.

The output device 51 is, for example, a display or a speaker. The display is, for example, an LCD or an organic EL display. The term "LCD" is an abbreviation for "liquid crystal display". The term "EL" is an abbreviation for "electroluminescent". The display may be a display audio. The output device 51 outputs information obtained by the operation of the information processing device 20.

The input device 52 is, for example, a physical key, a capacitance key, a pointing device, or a touch screen that is integrated with a display. The camera 53, the microphone 54, or both may also serve as the input device 52. The input device 52 receives an operation to input information to be used for the operation of the information processing device 20.

The camera 53 is, for example, a visible light camera or a depth camera. The camera 53 captures an image of the inside, outside, or both of the vehicle 50. The camera 53 outputs image information including the captured image.

The microphone 54 collects a sound from the inside, outside, or both of the vehicle 50. The microphone 54 outputs sound information including the collected sound.

The positioning device 55 is, for example, a GNSS receiver. The term "GNSS" is an abbreviation for "global navigation satellite system". The GNSS is, for example, GPS, QZSS, BDS, GLONASS, or Galileo. The term "GPS" is an abbreviation for "Global Positioning System". The term "QZSS" is an abbreviation for "Quasi-Zenith Satellite System". The satellites of the QZSS are referred to as quasi-zenith satellites. The term "BDS" is an abbreviation for "BeiDou Navigation Satellite System". The term "GLONASS" is an abbreviation for "Global Navigation Satellite System". The positioning device 55 measures the coordinates of the vehicle 50, i.e., the vehicle position. The positioning device 55 outputs position information including the measured vehicle position.

The various sensors 57 include, for example, a vehicle speed sensor, an acceleration sensor, a gyro, a human presence sensor, or a door opening/closing sensor. The various sensors 57 observe various events in various parts of the vehicle 50. The various sensors 57 output vehicle information including the results of observations.

The outline of the present embodiment will be described with reference to FIGS. 1 to 3.

The server device 30 selects, from among a plurality of terms-of-service texts, a terms-of-service text corresponding to the region associated with the vehicle 50, while giving priority to a terms-of-service text corresponding to the language for text display set in the information processing device 20. The terms-of-service texts correspond to different combinations of region and language. Each terms-of-service text includes the terms of use for the corresponding region written in the corresponding language. The language for text display is the language that is used to display various texts such as menus, guidance, or notifications when the user 11 uses various systems such as a multimedia system or various functions such as a connected service in the vehicle 50.

The server device 30 transmits the selected terms-of-service text to the information processing device 20 via the network 40. When the information processing device 20 receives the transmitted terms-of-service text from the server device 30 via the network 40, the information processing device 20 displays the received terms-of-service text on the display mounted on the vehicle 50.

When the information processing device 20 receives, via the input device 52 mounted on the vehicle 50, a user input indicating that the user agrees to the terms of use included in the displayed terms-of-service text, the information processing device 20 transmits one or more of the four kinds of information, namely the position information, the sound information, the image information, and the vehicle information, to the server device 30 in real time via the network 40. The position information is acquired via the positioning device 55 mounted on the vehicle 50. The sound information is acquired via the microphone 54 mounted on the vehicle 50. The image information is acquired via the camera 53 mounted on the vehicle 50. The vehicle information is acquired via the various sensors 57 mounted on the vehicle 50.

Thus, according to the present embodiment, a terms-of-service text suitable for the user 11 can be automatically displayed. As a result, convenience for the user 11 is improved.

For example, in regions where regulations require that the full text of the terms of use of a connected service be displayed on the screen of an in-vehicle device, it is conceivable that the information processing device 20 connects to a terms-of-service display website using a web browser function and automatically displays a terms-of-service text on the website. In such an example, the server device 30 automatically determines a display language for the terms-of-service text based on information on the country of contract associated with the vehicle 50, stored in the server device 30, and information on the language currently used by the user 11 for text display, transmitted from the information processing device 20. The information processing device 20 displays the terms-of-service text in the display language automatically determined by the server device 30. Therefore, it is possible not only to satisfy regulations, but also to reduce the time it takes to display the appropriate terms-of-service text. The user 11 does not need to manually select a combination of country and language on the website and therefore is not confused about how to select a terms-of-service text.

When there is only one language corresponding to the information on the country of contract, the server device 30 does not need to use the information on the language. In such a case, in order to improve the efficiency of processing, the server device 30 may not cause the information processing device 20 to transmit the information on the language. As an example, it is assumed that the information on the country of contract indicates the United Kingdom. It is assumed that the terms-of-service text for the United Kingdom is only available in English. In such a case, the server device 30 determines the display language for the terms-of-service text as English without referring to the information on the language.

Even when there are two or more languages corresponding to the information on the country of contract, and such languages do not include the language currently used by the user 11 for text display, the server device 30 determines the display language for the terms-of-service text from information other than the information on the language. For example, the server device 30 determines the display language for the terms-of-service text according to a priority order set in advance on the website. As an example, it is assumed that the information on the country of contract indicates Belgium and the information on the language indicates German. It is assumed that there are only two versions of the terms-of-service text for Belgian: Dutch and French. It is assumed that the Dutch version is given a higher priority order than the French version. In such a case, the server device 30 determines the display language for the terms-of-service text as Dutch. Alternatively, the server device 30 may determine the display language for the terms-of-service text by referring to information on the current location of the vehicle 50 transmitted from the information processing device 20. However, since the user 11 has not yet agreed to the terms of use, it is desirable that the information on the current location be information on a rough geographical range, rather than information that is as precise as the position information. It is desirable that the user 11 be able to opt out of providing information on the current location. As an example, it is assumed that the information on the country of contract indicates Belgium, the information on the language indicates German, and the information on the current location indicates the southern part of Belgium. It is assumed that there are only two versions of the terms-of-service text for Belgian: Dutch and French. It is assumed that the northern part of Belgium is defined as the Dutch speaking region and the southern part as the French speaking region. In such a case, the server device 30 determines the display language for the terms-of-service text as Dutch. Information on the current address of the user 11 may be used instead of the information on the current location. However, it is desirable that the user 11 be also able to opt out of providing information on the current address.

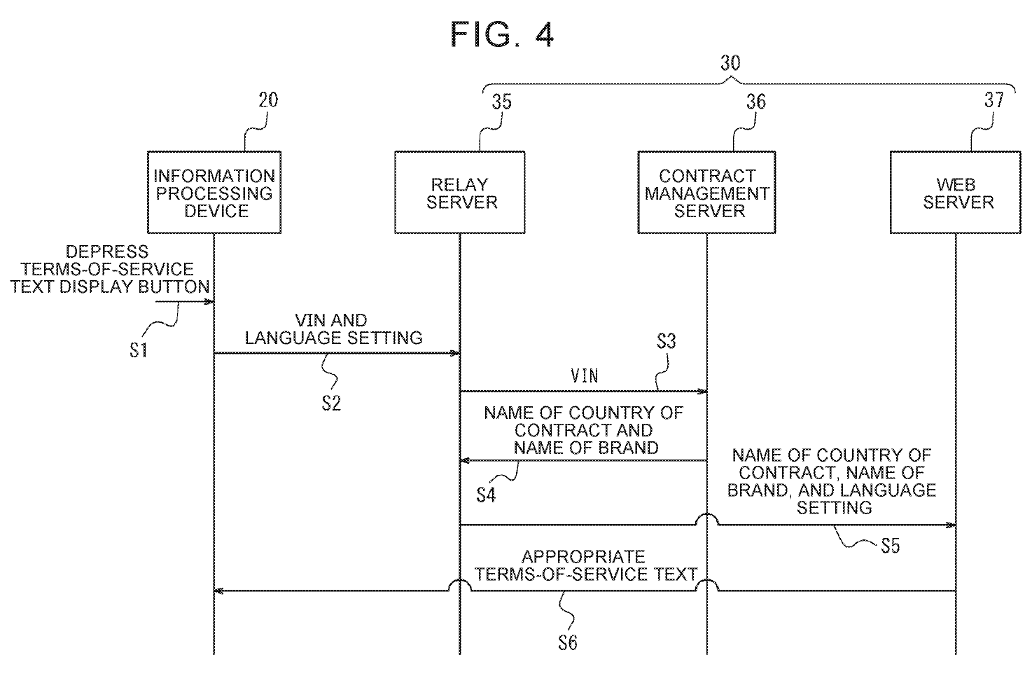

An example of the procedure for communication between the information processing device 20 and the server device 30 is illustrated in FIG. 4.

In this example, the server device 30 is implemented as a distributed system including a relay server 35, a contract management server 36, and a web server 37. The relay server 35, the contract management server 36, and the web server 37 can communicate with each other via the network 40.

In S1, when a terms-of-service text display button displayed on the display mounted on the vehicle 50 is depressed, in S2, the information processing device 20 transmits the VIN and the language setting of the vehicle 50 to the relay server 35 via the network 40. The term "VIN" is an abbreviation for "vehicle identification number". The language setting corresponds to the information on the language currently used by the user 11 for text display. The relay server 35 receives the VIN and the language setting from the information processing device 20.

In S3, the relay server 35 transmits the VIN received in S2 to the contract management server 36 via the network 40. The contract management server 36 receives the VIN from the relay server 35.

In S4, the contract management server 36 identifies the name of the country of contract and the name of the brand corresponding to the VIN received in S3 by searching the database 34. The name of the country of contract corresponds to the information on the country of contract associated with the vehicle 50. The contract management server 36 transmits the name of the country of contract and the name of the brand identified to the relay server 35 via the network 40. The relay server 35 receives the name of the country of contract and the name of the brand from the contract management server 36.

In S5, the relay server 35 transmits the name of the country of contract and the name of the brand received in S4 and the language setting received in S2 to the web server 37 via the network 40. The web server 37 receives the name of the country of contract, the name of the brand, and the language setting from the relay server 35.

In S6, the web server 37 determines the language in which to display the terms-of-service text for the connected service on the terms-of-service display website corresponding to the name of the country of contract and the name of the brand received in S5, according to the language setting received in S5. When the website does not have any terms-of-service text corresponding to the combination of the name of the country of contract, the name of the brand, and the language setting, that is, when the website does not support the language currently used by the user 11 for text display, the web server 37 determines to display the terms-of-service text in the default language for the country of contract. As an example, when the country of contract is France and the language currently used by the user 11 for text display is Estonian, the web server 37 may determine to display the terms-of-service text for France in French. When the website supports only one language, the web server 37 determines to display the terms-of-service text in the supported language, regardless of the language setting. When the website supports one or more languages, including the language currently used by the user 11 for text display, the web server 37 determines to display the terms-of-service text corresponding to the language setting. The web server 37 transmits the determined terms-of-service text to the information processing device 20 via the network 40 as the content of the terms-of-service display website. When the information processing device 20 receives the terms-of-service text from the web server 37 via the network 40, the information processing device 20 automatically displays the received terms-of-service text on the display using the web browser function.

The terms-of-service display website to which the information processing device 20 is to be connected may be different among the brand names. Each terms-of-service display website may hold terms-of-service texts for all countries and in all languages. That is, in S5, the relay server 35 may transmit the name of the country of contract received in S4 and the language setting received in S2 to the web server 37 corresponding to the name of the brand received in S4 via the network 40.

Instead of the web server 37, the relay server 35 may determine the language in which to display the terms-of-service text for the connected service on the terms-of-service display website corresponding to the name of the country of contract and the name of the brand received in S4, according to the language setting received in S2. The relay server 35 may then instruct the web server 37 to transmit the determined terms-of-service text to the information processing device 20 as the content of the terms-of-service display website.

As described above, in the present embodiment, the server device 30 identifies the terms-of-service text to be displayed by referring to the information on the country of contract and the brand obtained from contract information acquired using the VIN and the information on the language obtained from user settings of the in-vehicle device. Therefore, the appropriate terms-of-service text can be presented without manual selection by the user 11.

The configuration of the information processing device 20 according to the present embodiment will be described with reference to FIG. 1.

The information processing device 20 includes a control unit 21, a storage unit 22, and a communication unit 23.

The control unit 21 includes at least one processor, at least one programmable circuit, at least one dedicated circuit, or any combination of these. The processor is a general-purpose processor such as a CPU or GPU, or a dedicated processor specialized for a specific process. The term "CPU" is an abbreviation for "central processing unit". The term "GPU" is an abbreviation for "graphics processing unit". The programmable circuit is, for example, an FPGA. The term "FPGA" is an abbreviation for "field-programmable gate array". The dedicated circuit is, for example, an ASIC. The term "ASIC" is an abbreviation for "application specific integrated circuit". The control unit 21 executes processes related to the operation of the information processing device 20 while controlling the various units of the information processing device 20.

The storage unit 22 includes at least one semiconductor memory, at least one magnetic memory, at least one optical memory, or any combination of these. The semiconductor memory is, for example, a RAM, a ROM, or a flash memory. The term "RAM" is an abbreviation for "random access memory". The term "ROM" is an abbreviation for "read only memory". The RAM is, for example, an SRAM or a DRAM. The term "SRAM" is an abbreviation for "static random access memory". The term "DRAM" is an abbreviation for "dynamic random access memory". The ROM is, for example, an EEPROM. The term "EEPROM" is an abbreviation for "electrically erasable programmable read only memory". The flash memory is, for example, an SSD. The term "SSD" is an abbreviation for "solid-state drive". The magnetic memory is, for example, an HDD. The term "HDD" is an abbreviation for "hard disk drive". The storage unit 22 functions as, for example, a main storage device, an auxiliary storage device, or a cache memory. The storage unit 22 stores information to be used for the operation of the information processing device 20 and information obtained by the operation of the information processing device 20.

The communication unit 23 includes at least one communication module. The communication module is, for example, a module that supports a mobile communication standard such as LTE, 4G, or 5G, or a wireless LAN communication standard such as IEEE 802.11. The term "LTE" is an abbreviation for "Long Term Evolution". The term "4G" is an abbreviation for "fourth generation". The term "5G" is an abbreviation for "fifth generation". The term "IEEE" is an abbreviation for "Institute of Electrical and Electronics Engineers". The communication unit 23 communicates with the server device 30. The communication unit 23 receives the information to be used for the operation of the information processing device 20, and transmits the information obtained by the operation of the information processing device 20.

The functions of the information processing device 20 are implemented by executing an information processing program according to the present embodiment with a processor serving as the control unit 21. That is, the functions of the information processing device 20 are implemented by software. The information processing program causes a computer to function as the information processing device 20 by causing the computer to execute the operation of the information processing device 20. That is, the computer functions as the information processing device 20 by executing the operation of the information processing device 20 according to the information processing program.

Some or all of the functions of the information processing device 20 may be implemented by a programmable circuit or a dedicated circuit serving as the control unit 21. That is, some or all of the functions of the information processing device 20 may be implemented by hardware.

The configuration of the server device 30 according to the present embodiment will be described with reference to FIG. 1.

The server device 30 includes a control unit 31, a storage unit 32, and a communication unit 33.

The control unit 31 includes at least one processor, at least one programmable circuit, at least one dedicated circuit, or any combination of these. The processor is a general-purpose processor such as a CPU or GPU, or a dedicated processor specialized for a specific process. The programmable circuit is, for example, an FPGA. The dedicated circuit is, for example, an ASIC. The control unit 31 executes processes related to the operation of the server device 30 while controlling the various units of the server device 30.

The storage unit 32 includes at least one semiconductor memory, at least one magnetic memory, at least one optical memory, or any combination of these. The semiconductor memory is, for example, a RAM, a ROM, or a flash memory. The RAM is, for example, an SRAM or a DRAM. The ROM is, for example, an EEPROM. The flash memory is, for example, an SSD. The magnetic memory is, for example, an HDD. The storage unit 32 functions as, for example, a main storage device, an auxiliary storage device, or a cache memory. The storage unit 32 stores information to be used for the operation of the server device 30 and information obtained by the operation of the server device 30.

The communication unit 33 includes at least one communication module. The communication module is, for example, a module that supports a wired LAN communication standard such as Ethernet (registered trademark), or a wireless LAN communication standard such as IEEE 802.11. The communication unit 33 communicates with the information processing device 20. The communication unit 33 receives the information to be used for the operation of the server device 30, and transmits the information obtained by the operation of the server device 30.

The functions of the server device 30 are implemented by executing a server program according to the present embodiment with a processor serving as the control unit 31. That is, the functions of the server device 30 are implemented by software. The server program causes a computer to function as the server device 30 by causing the computer to execute the operation of the server device 30. That is, the computer functions as the server device 30 by executing the operation of the server device 30 according to the server program.

Some or all of the functions of the server device 30 may be implemented by a programmable circuit or a dedicated circuit serving as the control unit 31. That is, some or all of the functions of the server device 30 may be implemented by hardware.

The program such as the information processing program or the server program can be stored in a non-transitory computer-readable medium. The non-transitory computer-readable medium is, for example, a flash memory, a magnetic recording device, an optical disk, a magneto-optical recording medium, or a ROM. The program is distributed by, for example, selling, transferring, or renting a portable medium such as an SD card, a DVD, or a CD-ROM in which the program is stored. The term "SD" is an abbreviation for "Secure Digital". The term "DVD" is an abbreviation for "digital versatile disc". The term "CD-ROM" is an abbreviation for "compact disc read only memory". The program may be distributed by storing the program in a storage of a server and transferring the program from the server to other computers. The program may be provided as a program product.

The computer temporarily stores the program stored in the portable medium or the program transferred from the server in the main storage device, for example. The computer then causes the processor to read the program stored in the main storage device and causes the processor to execute processes according to the read program. The computer may read the program directly from the portable medium and execute processes according to the program. The computer may execute processes according to the received program each time the program is transferred from the server to the computer. The processes may be executed by a so-called ASP service in which the functions are implemented only by execution instructions and result acquisition, without transferring the program from the server to the computer. The term "ASP" is an abbreviation for "application service provider". The program includes information that is to be provided for processing by an electronic computer and that is equivalent to a program. For example, data that is not a direct command to a computer but has the property of defining the processing of the computer corresponds to the "information equivalent to a program".

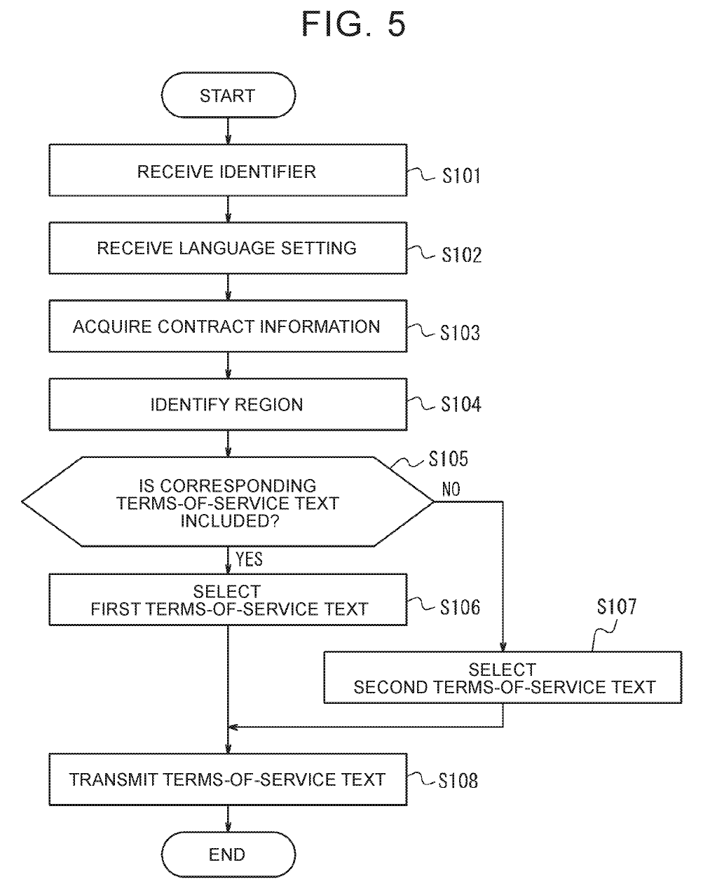

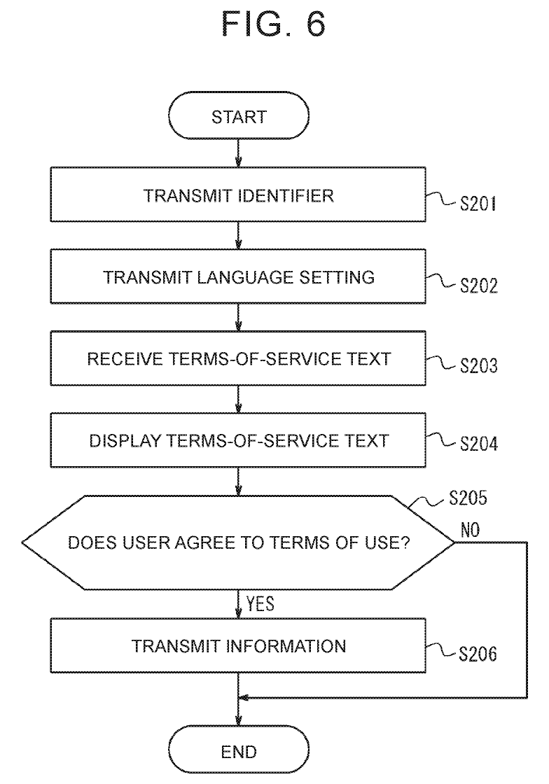

The operation of the server device 30 according to the present embodiment will be described with reference to FIG. 5. The operation of the information processing device 20 according to the present embodiment will be described with reference to FIG. 6. The operation described below corresponds to the text selection method according to the present embodiment. That is, the text selection method according to the present embodiment includes steps S101 to S108 illustrated in FIG. 5 and steps S201 to S206 illustrated in FIG. 6.

In S201 of FIG. 6, the control unit 21 of the information processing device 20 transmits the identifier of the vehicle 50 to the server device 30 via the communication unit 23. In the example illustrated in FIG. 4, the control unit 21 transmits the VIN of the vehicle 50 to the server device 30 via the communication unit 23.

In S101 of FIG. 5, the control unit 31 of the server device 30 receives the identifier transmitted in S201 of FIG. 6 from the information processing device 20 via the communication unit 33. In the example illustrated in FIG. 4, the control unit 31 receives the VIN transmitted in S201 of FIG. 6 from the information processing device 20 via the communication unit 33.

In S202 of FIG. 6, the control unit 21 of the information processing device 20 transmits the setting of the language for text display set in the information processing device 20 to the server device 30 via the communication unit 23. In the example illustrated in FIG. 4, the control unit 21 transmits the language setting of the vehicle 50 to the server device 30 via the communication unit 23.

In S102 of FIG. 5, the control unit 31 of the server device 30 receives the setting transmitted in S202 of FIG. 6 from the information processing device 20 via the communication unit 33. In the example illustrated in FIG. 4, the control unit 31 receives the language setting transmitted in S202 of FIG. 6 from the information processing device 20 via the communication unit 33.

In the present embodiment, when the control unit 21 of the information processing device 20 receives a user input for setting the language for text display via the input device 52, the control unit 21 displays various texts, excluding the received terms-of-service text, in the set language on the display. In the example illustrated in FIG. 4, the control unit 21 displays a screen including a user interface for selecting the language to be used for text display on the display. When the control unit 21 receives a touch input to select German on the screen displayed on the display via the touch screen, the control unit 21 sets the language to be used for text display to German. From then on, when the user 11 uses various systems such as a multimedia system or various functions such as a connected service in the vehicle 50, the control unit 21 displays various texts such as menus, guidance, or notifications in German on the display.

In S103 of FIG. 5, the control unit 31 of the server device 30 acquires, from the database 34, contract information corresponding to the identifier received in S101. In the example illustrated in FIG. 4, the control unit 31 searches the database 34.

In S104 of FIG. 5, the control unit 31 of the server device 30 identifies the region associated with the vehicle 50 based on the contract information acquired in S103. In the present embodiment, the region associated with the vehicle 50 is the country of contract of the vehicle 50. In the example illustrated in FIG. 4, the control unit 31 identifies the name of the country of contract and the name of the brand corresponding to the VIN received in S101.

In S105 of FIG. 5, the control unit 31 of the server device 30 refers to the setting received in S102 and determines whether terms-of-service texts corresponding to the region identified in S104 include the terms-of-service text corresponding to the language for text display set in the information processing device 20. In the example illustrated in FIG. 4, the control unit 31 refers to the language setting received in S102 and determines whether the terms-of-service display website corresponding to the name of the country of contract and the name of the brand identified in S104 supports the language currently used by the user 11 for text display.

When it is determined in S105 of FIG. 5 that the terms-of-service text corresponding to the language for text display set in the information processing device 20 is included, step S106 is executed. On the other hand, when it is determined that the terms-of-service text corresponding to the language for text display set in the information processing device 20 is not included, step S107 is executed. In the example illustrated in FIG. 4, when the terms-of-service display website corresponding to the name of the country of contract and the name of the brand identified in S104 supports the language currently used by the user 11 for text display, step S106 is executed. Otherwise, step S107 is executed.

In S106 of FIG. 5, the control unit 31 of the server device 30 selects the terms-of-service text corresponding to the language for text display set in the information processing device 20 as a first terms-of-service text. In the example illustrated in FIG. 4, the control unit 31 determines to display the terms-of-service text in the language currently used by the user 11 for text display on the terms-of-service display website corresponding to the name of the country of contract and the name of the brand identified in S104. After S106, step S108 is executed.

In S107 of FIG. 5, the control unit 31 of the server device 30 selects, as a second terms-of-service text, one of the terms-of-service texts corresponding to the region identified in S104 according to a priority order set in advance. In the example illustrated in FIG. 4, the control unit 31 determines to display the terms-of-service text in the default language for the country of contract on the terms-of-service display website corresponding to the name of the country of contract and the name of the brand identified in S104. After S107, step S108 is executed.

In S108 of FIG. 5, the control unit 31 of the server device 30 transmits the first terms-of-service text when the first terms-of-service text was selected in S106, or the second terms-of-service text when the second terms-of-service text was selected in S107, to the information processing device 20 via the communication unit 33. In the example illustrated in FIG. 4, the control unit 31 transmits the terms-of-service text determined in S106 or S107 to the information processing device 20 as the content of the terms-of-service display website.

In S203 of FIG. 6, the control unit 21 of the information processing device 20 receives the terms-of-service text transmitted in S108 of FIG. 5 from the server device 30 via the communication unit 23.

In S204 of FIG. 6, the control unit 21 of the information processing device 20 displays the terms-of-service text received in S203 on the display. For example, the control unit 21 displays, on the display, a screen including the terms-of-service text received in S203 and a user interface for selecting to "agree" or "disagree".

In S205 of FIG. 6, the control unit 21 of the information processing device 20 receives a user input indicating whether the user agrees to the terms of use included in the terms-of-service text displayed in S204 via the input device 52. For example, the control unit 21 receives a touch input to select to "agree" or "disagree" on the screen displayed on the display via the touch screen.

When a user input indicating that the user agrees to the terms of use is received in S205 of FIG. 6, step S206 is executed. When a user input indicating that the user does not agree to the terms of use is received in S205, step S206 is not executed. For example, when "agree" is selected in S205, step S206 is executed. When "disagree" is selected in S205, step S206 is not executed.

In S206 of FIG. 6, the control unit 21 of the information processing device 20 transmits the information collected by the vehicle 50 to the server device 30 via the communication unit 23. The information collected by the vehicle 50 includes one or more of the four kinds of information, namely the position information, the sound information, the image information, and the vehicle information respectively acquired via the positioning device 55, the microphone 54, the camera 53, and the various sensors 57.

The control unit 21 of the information processing device 20 may associate the information collected by the vehicle 50 with various additional information and transmit the information to the server device 30 via the communication unit 23. The additional information may include, for example, an identifier of the user 11, an identifier of the vehicle 50, or both, the time when the information was acquired, the driving condition of the vehicle 50 at the time when the information was acquired, or the kind of the acquired information. The information transmitted to the server device 30, together with the additional information, may be utilized by a business operator that operates the server device 30. Alternatively, the information transmitted to the server device 30 may be secondarily provided to a third party by the business operator that operates the server device 30, together with the additional information or with some of the additional information hidden and may be utilized by the third party.

As described above, in the present embodiment, the control unit 31 of the server device 30 selects, from among a plurality of terms-of-service texts, a terms-of-service text corresponding to the region associated with the vehicle 50, while giving priority to a terms-of-service text corresponding to the language for text display set in the information processing device 20. The control unit 31 transmits the selected terms-of-service text to the information processing device 20 via the communication unit 33. The control unit 21 of the information processing device 20 receives the transmitted terms-of-service text from the server device 30 via the communication unit 23. The control unit 21 displays the received terms-of-service text on the display.

Thus, according to the present embodiment, a terms-of-service text suitable for the user 11 can be automatically displayed. As a result, convenience for the user 11 is improved.

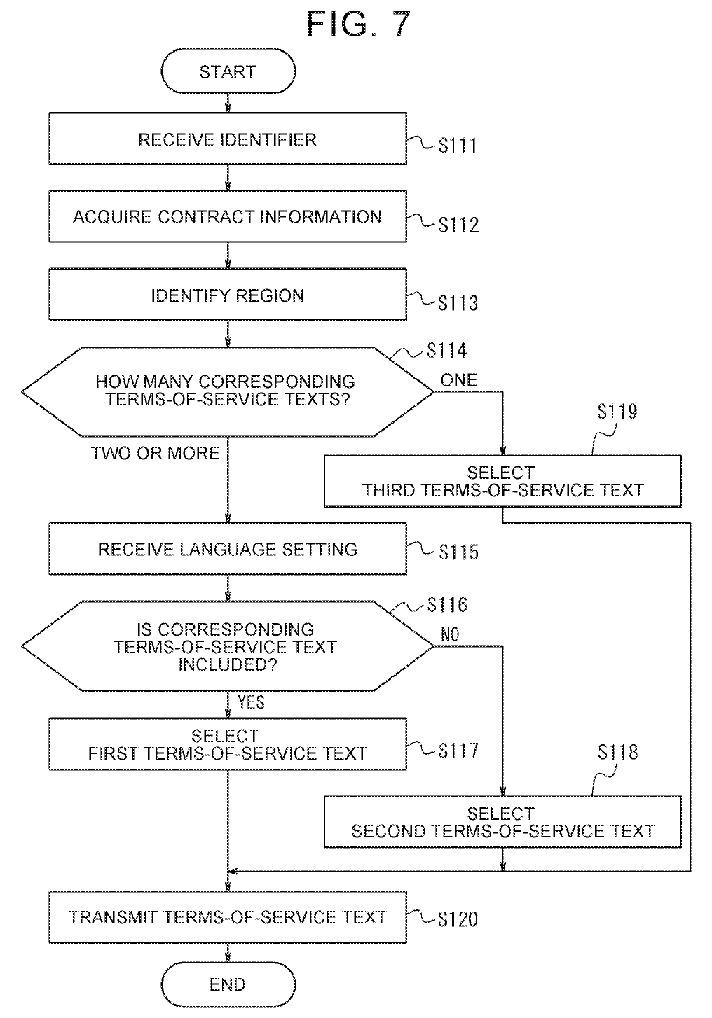

A modification of the operation of the server device 30 according to the present embodiment will be described with reference to FIG. 7.

Step S111 is the same as step S101 of FIG. 5, and therefore the description thereof will be omitted. Steps S112 and S113 are the same as steps S103 and S104 of FIG. 5, respectively, and therefore the description thereof will be omitted.

In S114, the control unit 31 of the server device 30 determines how many terms-of-service texts corresponding to the region identified in S113 are included in the terms-of-service texts. In the example illustrated in FIG. 4, the control unit 31 determines how many languages are supported by the terms-of-service display website corresponding to the name of the country of contract and the name of the brand identified in S113.

When it is determined in S114 that two or more do, step S115 is executed. Meanwhile, when it is determined that one does, step S119 is executed. In the example illustrated in FIG. 4, when two or more languages are supported by the terms-of-service display website corresponding to the name of the country of contract and the name of the brand identified in S113, step S115 is executed. Otherwise, step S119 is executed.

In S115, the control unit 31 of the server device 30 requests, via the communication unit 33, the information processing device 20 to transmit the setting of the language for text display set in the information processing device 20. In response to this request, step S202 of FIG. 6 is executed. That is, in response to the request from the server device 30, the control unit 21 of the information processing device 20 transmits the setting of the language for text display set in the information processing device 20 to the server device 30 via the communication unit 23. The control unit 31 of the server device 30 receives the setting transmitted in S202 of FIG. 6 from the information processing device 20. In the example illustrated in FIG. 4, the control unit 31 receives the language setting transmitted in S202 of FIG. 6 from the information processing device 20 via the communication unit 33. After S115, step S116 is executed.

Steps S116 to S118 are the same as steps S105 to S107 of FIG. 5, respectively, and therefore the description thereof will be omitted. After S117, step S120 is executed. Also after S118, step S120 is executed.

In S119, the control unit 31 of the server device 30 does not request the information processing device 20 to transmit the setting of the language for text display set in the information processing device 20. Therefore, step S202 of FIG. 6 is skipped. The control unit 31 of the server device 30 selects, as a third terms-of-service text, the only one terms-of-service text included in the terms-of-service texts and corresponding to the region identified in S113. In the example illustrated in FIG. 4, the control unit 31 determines to display the terms-of-service text on the terms-of-service display website corresponding to the name of the country of contract and the name of the brand identified in S104 in the only language supported by the website. After S119, step S120 is executed.

In S120, the control unit 31 of the server device 30 transmits the first terms-of-service text when the first terms-of-service text was selected in S117, the second terms-of-service text when the second terms-of-service text was selected in S118, or the third terms-of-service text when the third terms-of-service text was selected in S119, to the information processing device 20 via the communication unit 33. In the example illustrated in FIG. 4, the control unit 31 transmits the terms-of-service text determined in S117, S118, or S119 to the information processing device 20 as the content of the terms-of-service display website.

The present disclosure is not limited to the embodiment described above. For example, two or more blocks illustrated in the block diagrams may be integrated, or a single block may be divided. Instead of executing two or more steps illustrated in the flowcharts in chronological order according to the description, the steps may be executed in parallel or in a different order, depending on the processing capacities of the devices that execute the steps, or as necessary. Other changes may be made without departing from the spirit and scope of the present disclosure.

Some of the embodiments of the present disclosure will be given below. However, it should be noted that the embodiments of the present disclosure are not limited to these.

### Appendix 1

A system including a server device configured to select a first terms-of-service text corresponding to a region associated with a vehicle from among a plurality of terms-of-service texts, the terms-of-service texts each corresponding to a different combination of a region and a language and including terms of use for the corresponding region written in the corresponding language, and transmit the selected first terms-of-service text to an information processing device via a network; and the information processing device installed in a vehicle, the information processing device configured to when the transmitted first terms-of-service text is received from the server device via the network, display the received first terms-of-service text on a display mounted on the vehicle, and when a user input indicating that a user agrees to the terms of use included in the displayed first terms-of-service text is received via an input device mounted on the vehicle, transmit one or more of four kinds of information to the server device in real time via the network, the four kinds of information including position information, sound information, image information, and vehicle information respectively acquired via a positioning device, a microphone, a camera, and various sensors mounted on the vehicle, in which the server device is configured to preferentially select a terms-of-service text corresponding to a language for text display set in the information processing device as the first terms-of-service text.

### Appendix 2

A server device including: a communication unit configured to communicate with an information processing device installed in a vehicle; and a processor configured to select a first terms-of-service text corresponding to a region associated with the vehicle from among a plurality of terms-of-service texts, the terms-of-service texts each corresponding to a different combination of a region and a language and including terms of use for the corresponding region written in the corresponding language, and transmit the selected first terms-of-service text to the information processing device via the communication unit, in which the processor is configured to preferentially select a terms-of-service text corresponding to a language for text display set in the information processing device as the first terms-of-service text.

### Appendix 3

The server device according to appendix 2, in which the processor is configured to receive an identifier of the vehicle from the information processing device via the communication unit, acquire contract information corresponding to the received identifier from a database, and identify the region associated with the vehicle based on the acquired contract information.

### Appendix 4

The server device according to appendix 3, in which the region associated with the vehicle is a country of contract of the vehicle.

### Appendix 5

The server device according to any one of appendices 2 to 4, in which the processor is configured to when there are two or more terms-of-service texts corresponding to the region associated with the vehicle and included in the terms-of-service texts, request the information processing device to transmit setting of the language for text display set in the information processing device via the communication unit, and when there is one terms-of-service text corresponding to the region associated with the vehicle, not request the information processing device to transmit the setting of the language for text display set in the information processing device.

### Appendix 6

The server device according to appendix 5, in which the processor is configured to receive the setting of the language for text display set in the information processing device from the information processing device via the communication unit, when a terms-of-service text corresponding to the language for text display set in the information processing device is included in the terms-of-service texts corresponding to the region associated with the vehicle, select the terms-of-service text corresponding to the language for text display set in the information processing device as the first terms-of-service text, and when the terms-of-service text corresponding to the language for text display set in the information processing device is not included, select the first terms-of-service text from among the terms-of-service texts corresponding to the region associated with the vehicle according to a priority order set in advance.

### Appendix 7

A system comprising the server device according to any one of appendices 2 to 6 and the information processing device.

### Appendix 8

The system according to appendix 7, in which the information processing device is configured to when a terms-of-service text transmitted by the processor is received from the server device, display the received terms-of-service text on a display mounted on the vehicle, and when a user input indicating that a user agrees to the terms of use included in the displayed terms-of-service text is received via an input device mounted on the vehicle, transmit information collected in the vehicle to the server device.

### Appendix 9

The system according to appendix 8, in which the information collected in the vehicle includes one or more of four kinds of information including position information, sound information, image information, and vehicle information respectively acquired via a positioning device, a microphone, a camera, and various sensors mounted on the vehicle.

### Appendix 10

An information processing device installed in a vehicle, including: a communication unit configured to communicate with a server device; and a processor configured to when a first terms-of-service text corresponding to a region associated with the vehicle and selected from among a plurality of terms-of-service texts is received from the server device via the communication unit, display the received terms-of-service text on a display mounted on the vehicle, the terms-of-service texts each corresponding to a different combination of a region and a language and including terms of use for the corresponding region written in the corresponding language, and when a user input indicating that a user agrees to the terms of use included in the displayed terms-of-service text is received via an input device mounted on the vehicle, transmit information collected in the vehicle to the server device via the communication unit, in which a terms-of-service text corresponding to a language for text display set in the information processing device is preferentially selected as the first terms-of-service text.

### Appendix 11

The information processing device according to appendix 10, in which the processor is configured to transmit an identifier of the vehicle to the server device via the communication unit and receive from the server device a terms-of-service text corresponding to a region identified based on contract information corresponding to the transmitted identifier.

### Appendix 12

The information processing device according to appendix 11, in which the region associated with the vehicle is a country of contract of the vehicle.

### Appendix 13

The information processing device according to any one of appendices 10 to 12, in which the processor is configured to transmit setting of the language for text display set in the information processing device to the server device via the communication unit in response to a request from the server device.

### Appendix 14

The information processing device according to any one of appendices 10 to 13, in which the processor is configured to when a user input for setting the language for text display is received via the input device, display various texts, excluding the received terms-of-service text, in the set language on the display.

### Appendix 15

The information processing device according to any one of appendices 10 to 14, in which the information collected in the vehicle includes position information acquired via a positioning device mounted on the vehicle.

### Appendix 16

The information processing device according to any one of appendices 10 to 15, in which the information collected in the vehicle includes sound information acquired via a microphone mounted on the vehicle.

### Appendix 17

The information processing device according to any one of appendices 10 to 16, in which the information collected in the vehicle includes image information acquired via a camera mounted on the vehicle.

### Appendix 18

The information processing device according to any one of appendices 10 to 17, in which the information collected in the vehicle includes vehicle information acquired via various sensors mounted on the vehicle.

### Appendix 19

A system comprising the information processing device according to any one of appendices 10 to 18 and the server device.

### Appendix 20

A vehicle comprising the information processing device according to any one of appendices 10 to 18.

What is claimed is:

1. A system comprising:
a server device configured to
select a first terms-of-service text corresponding to a region associated with a vehicle from among a plurality of terms-of-service texts, the terms-of-service texts each corresponding to a different combination of a region and a language and including terms of use for the corresponding region written in the corresponding language, and
transmit the selected first terms-of-service text to an information processing device via a network; and
the information processing device installed in the vehicle, the information processing device configured to
when the transmitted first terms-of-service text is received from the server device via the network, display the received first terms-of-service text on a display mounted on the vehicle, and
when a user input indicating that a user agrees to the terms of use included in the displayed first terms-of-service text is received via an input device mounted on the vehicle, transmit one or more of four kinds of information to the server device in real time via the network, the four kinds of information including position information, sound information, image information, and vehicle information respectively acquired via a positioning device, a microphone, a camera, and various sensors mounted on the vehicle, wherein
the server device is configured to preferentially select a terms-of-service text corresponding to a language for text display set in the information processing device as the first terms-of-service text.

2. A server device comprising:
a communication unit configured to communicate with an information processing device installed in a vehicle; and
a processor configured to
select a first terms-of-service text corresponding to a region associated with the vehicle from among a plurality of terms-of-service texts, the terms-of-service texts each corresponding to a different combination of a region and a language and including terms of use for the corresponding region written in the corresponding language, and
transmit the selected first terms-of-service text to the information processing device via the communication unit, wherein
the processor is configured to preferentially select a terms-of-service text corresponding to a language for text display set in the information processing device as the first terms-of-service text.

3. The server device according to claim 2, wherein the processor is configured to
receive an identifier of the vehicle from the information processing device via the communication unit,
acquire contract information corresponding to the received identifier from a database, and
identify the region associated with the vehicle based on the acquired contract information.

4. The server device according to claim 3, wherein the region associated with the vehicle is a country of contract of the vehicle.

5. The server device according to claim 2, wherein the processor is configured to
when there are two or more terms-of-service texts corresponding to the region associated with the vehicle and included in the terms-of-service texts, request the information processing device to transmit setting of the language for text display set in the information processing device via the communication unit, and
when there is one terms-of-service text corresponding to the region associated with the vehicle, not request the information processing device to transmit the setting of the language for text display set in the information processing device.

6. The server device according to claim 5, wherein the processor is configured to
receive the setting of the language for text display set in the information processing device from the information processing device via the communication unit,
when a terms-of-service text corresponding to the language for text display set in the information processing device is included in the terms-of-service texts corresponding to the region associated with the vehicle, select the terms-of-service text corresponding to the language for text display set in the information processing device as the first terms-of-service text, and
when the terms-of-service text corresponding to the language for text display set in the information processing device is not included, select the first terms-of-service text from among the terms-of-service texts corresponding to the region associated with the vehicle according to a priority order set in advance.

7. A system comprising the server device according to claim 2 and the information processing device.

8. The system according to claim 7, wherein the information processing device is configured to
when a terms-of-service text transmitted by the processor is received from the server device, display the received terms-of-service text on a display mounted on the vehicle, and
when a user input indicating that a user agrees to the terms of use included in the displayed terms-of-service text is received via an input device mounted on the vehicle, transmit information collected in the vehicle to the server device.

9. The system according to claim 8, wherein the information collected in the vehicle includes one or more of four kinds of information including position information, sound information, image information, and vehicle information respectively acquired via a positioning device, a microphone, a camera, and various sensors mounted on the vehicle.

10. An information processing device installed in a vehicle, comprising:
a communication unit configured to communicate with a server device; and
a processor configured to
when a first terms-of-service text corresponding to a region associated with the vehicle and selected from among a plurality of terms-of-service texts is received from the server device via the communication unit, display the received terms-of-service text on a display mounted on the vehicle, the terms-of-service texts each corresponding to a different combination of a region and a language and including terms of use for the corresponding region written in the corresponding language, and
when a user input indicating that a user agrees to the terms of use included in the displayed terms-of-service text is received via an input device mounted on the vehicle, transmit information collected in the vehicle to the server device via the communication unit, wherein
a terms-of-service text corresponding to a language for text display set in the information processing device is preferentially selected as the first terms-of-service text.

11. The information processing device according to claim 10, wherein the processor is configured to transmit an identifier of the vehicle to the server device via the communication unit, and receive from the server device a terms-of-service text corresponding to a region identified based on contract information corresponding to the transmitted identifier.

12. The information processing device according to claim 11, wherein the region associated with the vehicle is a country of contract of the vehicle.

13. The information processing device according to claim 10, wherein the processor is configured to transmit setting of the language for text display set in the information processing device to the server device via the communication unit in response to a request from the server device.

14. The information processing device according to claim 10, wherein the processor is configured to when a user input for setting the language for text display is received via the input device, display various texts, excluding the received terms-of-service text, in the set language on the display.

15. The information processing device according to claim 10, wherein the information collected in the vehicle includes position information acquired via a positioning device mounted on the vehicle.

16. The information processing device according to claim 10, wherein the information collected in the vehicle includes sound information acquired via a microphone mounted on the vehicle.

17. The information processing device according to claim 10, wherein the information collected in the vehicle includes image information acquired via a camera mounted on the vehicle.

18. The information processing device according to claim 10, wherein the information collected in the vehicle includes vehicle information acquired via various sensors mounted on the vehicle.

19. A system comprising the information processing device according to claim 10 and the server device.

20. A vehicle comprising the information processing device according to claim 10.
